(19) United States
(12) Patent Application Publication
(10) Pub. No.: US 2026/0352331 A1
(43) Pub. Date: Nov. 5, 2026

(54) SYSTEM HAVING RECEIVER NODE AND SPACED APART RYDBERG SENSOR NODE AND ASSOCIATED METHODS

(71) Applicant: Eagle Technology, LLC, Melbourne, FL (US)

(72) Inventors: Victor G. BUCKLEW, Richmond, VA (US); James DRAKES, Occoquan, VA (US); Michael R. LANGE, Melbourne, FL (US); Samuel H. KNARR, Melbourne, FL (US); Donna M. KOCAK, Satellite Beach, FL (US); Charles R. TOWERY, Melbourne, FL (US); Uma Shanker JHA, Indian Harbour Beach, FL (US)

(21) Appl. No.: 18/439,791

(22) Filed: Feb. 13, 2024

(51) Int. Cl. H04B 10/11; H04B 10/25; H04B 10/80

(52) U.S. Cl. CPC H04B 10/11; H04B 10/25; H04B 10/80

(57) ABSTRACT

A system may include a receiver node and a Rydberg sensor node in spaced apart relation from the receiver node. A coupling laser and a probe laser may cooperate with the Rydberg sensor node to generate a laser output to the receiver node based upon a received radio frequency (RF) signal. The coupling laser and probe laser may define a transmitter node in spaced apart relation from the Rydberg sensor node. The transmitter node may be co-located with the receiver node.

### FIELD OF THE INVENTION

The present invention relates to the field of optical communications, and, more particularly, to a Rydberg sensor node that generates a laser output to a spaced apart receiver node based upon a received radio frequency (RF) signal.

### BACKGROUND OF THE INVENTION

Radio frequency (RF) signals are generated and received in communications, sensing, and intelligence applications across a wide range of commercial markets and government divisions. Emerging RF applications are pushing requirements to higher frequency ranges with new waveforms that are difficult to detect and require RF receivers or sensors that have increased sensitivity. As RF channels become more heavily crowded, there is a desire to push to alternative RF bands spanning from tens of KHz to 300 MHz, and beyond. While some RF receivers and sensors span multiple bands, most are band-limited and can cover only a few tens of GHz, with a typical upper limit of about 40 GHz, e.g., Ka band. Also, some state-of-the-art RF receivers and sensors are not compatible with new waveforms used in emerging distributed sensing networks, and new RF applications that are sensitivity limited or not served with existing narrow band antenna–based receivers.

Conventional RF devices that incorporate RF antennas have a high technology readiness level (TRL) and are used in almost every modern RF sensing or communications system. There are limitations with RF antennas, however, because they are Size, Weight and Power (SWaP) limited. The antenna is also on the order of the RF wavelength of radiation, and the RF coverage is over a relatively narrow frequency band, such as 1-10 GHz or 20-40 GHz. Many conventional RF devices employ antenna designs that are not compatible with emerging waveforms and may lack sensitivity, making them difficult to cover wide bandwidths, such as tens of KHz to 300 MHz with high sensitivity.

To address these limitations, Rydberg atom–based RF sensors have been developed, which convert the response of an atomic vapor to incoming RF radiation into measurable changes in an optical probe. These RF sensors provide a new model for RF sensing with increased sensitivity.

In a Rydberg atom-based RF sensor, the measurement is based upon the attenuation of a probe laser due to absorption in a small room temperature vapor cell filled with alkali atoms, such as rubidium (Rb) or cesium (Cs). In a 2-photon/laser Rydberg sensing system, atoms are simultaneously excited into a “Rydberg” state with both a coupling and probe. These Rydberg states are very responsive to local electric fields and the response of the atom to an external electric field, such as an RF signal, alters the measured attenuation of the probe laser and is detected by a probe laser photo detector. For that reason, Rydberg sensors have been incorporated into different communications systems.

However, ensuring reliable, on-demand communication capabilities is an ongoing challenge in communication environments that are becoming increasingly more complex and crowded, even with the use of Rydberg sensors. The need to provide RF communications and detect RF communication signals between non-line-of-sight (LOS) communication nodes, or to quickly reconfigure communication nodes, is not facilitated with standard RF antenna relays or receivers, especially for frequencies that require larger antennas. The requirement to receive on an intermediate node, and then retransmit, can be cumbersome; slow; and size, weight and power (SWaP) incompatible with mission or commercial requirements.

Furthermore, in many concepts of operations, one or more communication nodes in non-LOS communications/sensing systems are SWaP limited, which prevents using a large RF antenna for ground collections, even if an intermediate node could be appropriately designed for the system. A low-SWaP, low latency, reconfigurable RF sensing-receiving architecture may provide an asset for mobile, ad-hoc, non-LOS communications, and early warning detection for many different communication requirements. The need to provide RF communications between non-LOS communication nodes may not be facilitated with standard RF technology, based on relays or bouncing communication signals off of objects such as the ionosphere or buildings. This is especially true for frequencies that require larger antennas. Even if a Rydberg sensor operating as a receiver is substituted for a more conventional RF transceiver, many conventional Rydberg sensors are limited to line-of-sight communications.

This requirement becomes even more challenging if very secure quantum communications are desired where information is exchanged between a transmitter node and a receiver node using encoded single photons. Each photon may carry information that is encoded on a property of the photons, such as its polarization, phase or energy and time. Quantum communication systems generally require sending information from one node to another node, such as a transmitter node, usually referred to as “Alice” and a receiver node, usually referred to as “Bob.” Quantum communications may encompass quantum key distribution (QKD) systems that allow sharing of cryptographic key, quantum random number generator (QRNG) systems that use inherent indeterminacy of quantum entangled photons to produce random binary digits, and quantum secure direct communication (QSDC) systems that transfer direct information between Alice and Bob without a distribution key and other quantum protocols. Further improvements in Rydberg receivers and sensors and quantum communication systems are desirable to enhance secure non-LOS communications.

### SUMMARY OF THE INVENTION

In general, a system may comprise a receiver node and a Rydberg sensor node in spaced apart relation from the receiver node. A coupling laser and a probe laser may cooperate with the Rydberg sensor node to generate a laser output to the receiver node based upon a received radio frequency (RF) signal.

The coupling laser and probe laser may define a transmitter node in spaced apart relation from the Rydberg sensor node. The transmitter node may be co-located with the receiver node. The laser output may comprise a free space laser output beam. The receiver node and the Rydberg sensor node each may comprise a respective pointing and tracking arrangement for the free space laser output beam.

The receiver node and the Rydberg sensor node may be underwater and the laser output may comprise an underwater laser output beam. In other embodiments, an optical fiber may be between the receiver node and Rydberg sensor node and the laser output may comprise an optical fiber laser output.

The Rydberg sensor node may comprise an aerial propulsion system and a controller coupled thereto in some embodiments. The receiver node may comprise a terrestrial receiver node in other embodiments. At least one other Rydberg sensor node may cooperate with the receiver node and the coupling laser and probe laser.

Another aspect is directed to a method of receiving a radio frequency (RF) signal that may comprise operating a Rydberg sensor node in spaced apart relation from a receiver node. The method may also include operating a coupling laser and a probe laser cooperating with the Rydberg sensor node to generate a laser output to the receiver node based upon an RF signal.

### BRIEF DESCRIPTION OF THE DRAWINGS

Other objects, features and advantages of the present invention will become apparent from the detailed description of the invention which follows, when considered in light of the accompanying drawings in which:

FIG. 1 is a block diagram of the system having the Rydberg sensor node in spaced apart relation from the receiver node according to the invention.

FIG. 2 is a block diagram showing a more detailed example of the system of FIG. 1, where the transmitter and receiver nodes are co-located in the same platform.

FIG. 3 is a schematic diagram of the system showing the transmitter node, Rydberg sensor node, and receiver node in spaced apart relation.

FIG. 4 is a schematic diagram showing at least one other Rydberg sensor node cooperating with the receiver node.

FIG. 5 is a schematic diagram similar to FIG. 4 showing Rydberg sensor nodes cooperating as an advance warning for satellites.

FIG. 6 is a high-level flowchart of a method for receiving the radio frequency (RF) signal using the system of FIG. 1.

FIG. 7 is a block diagram of the system having the Rydberg sensor node in spaced apart relation from the receiver node and configured to generate a quantum secure laser output according to the invention.

FIG. 8 is a schematic diagram showing the Rydberg sensor node, transmitter node, and receiver node in spaced apart relation from each other and the generated quantum secure laser output.

FIG. 9 is a schematic diagram showing at least one other Rydberg sensor node cooperating with the receiver node with each Rydberg sensor node generating a quantum secure laser output to the receiver node.

FIG. 10 is a high-level flowchart showing a method for radio frequency (RF) communication using the system of FIG. 7.

### DETAILED DESCRIPTION

The present description is made with reference to the accompanying drawings, in which exemplary embodiments are shown. However, many different embodiments may be used, and thus, the description should not be construed as limited to the particular embodiments set forth herein. Rather, these embodiments are provided so that this disclosure will be thorough and complete. Like numbers refer to like elements throughout.

As will be described in detail below, the system 20 is an improvement over existing Rydberg sensors having one Rydberg sensor head that integrates into one housing the coupling laser, probe laser, Rydberg sensor cells, and the detector as part of a receiver component. An example of this type of Rydberg sensor is described in U.S. Patent No. 11,598,798 to Bucklew et al., assigned to Eagle Technology, LLC, the disclosure of which is incorporated herein by reference in its entirety. The system 20 decouples the receiver component from the Rydberg cell, and in an example, may decouple the probe and coupling lasers so that the Rydberg cell may operate as a Rydberg sensor node spaced apart from a receiver node that contains a detector, and in an example, spaced apart from a transmitter node that contains the probe and coupling lasers.

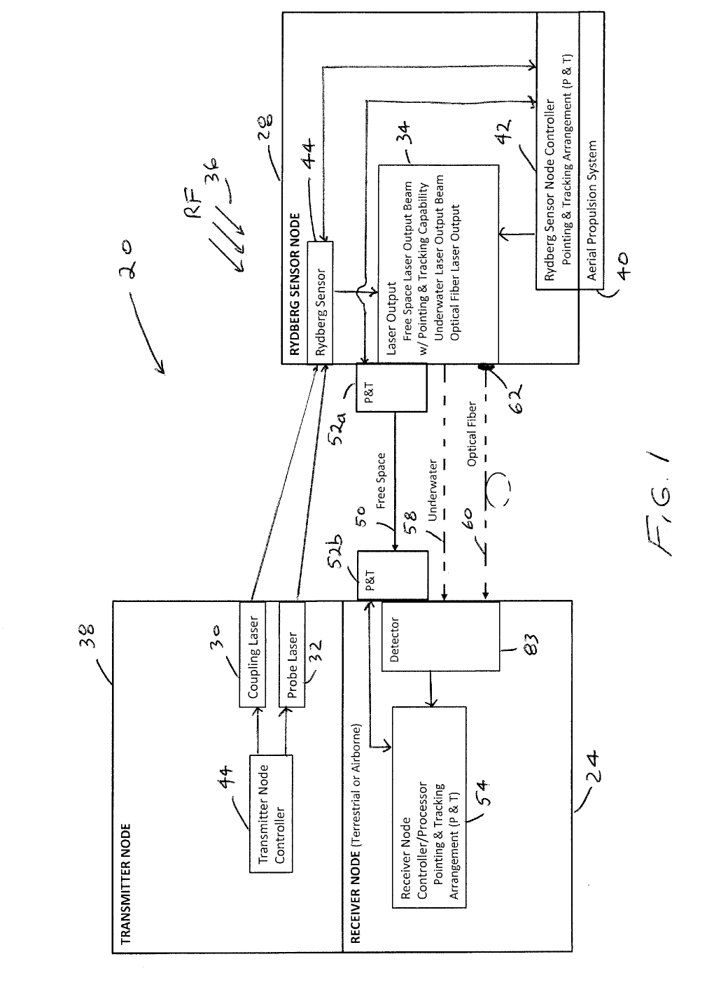

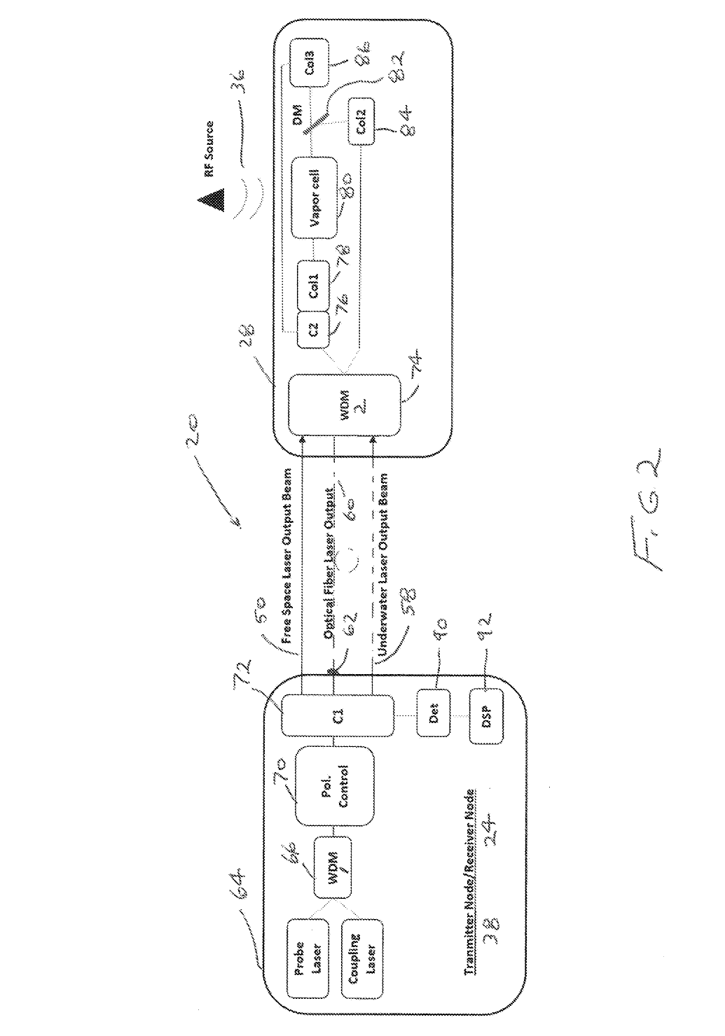

Referring initially to FIG. 1, the system 20 includes a receiver node 24 and the Rydberg sensor node 28 that is in spaced apart relation from the receiver node. A coupling laser 30 and probe laser 32 cooperate with the Rydberg sensor node 28 to generate a laser output 34 to the receiver node 24 based upon a received radio frequency (RF) signal indicated generally at 36. The RF signals 36 may be transmitted from a satellite, ground-based transmitter, aircraft, airborne device such as a drone, or other RF transmitter device. As illustrated, the coupling laser 30 and probe laser 32 may define a transmitter node 38 in spaced apart relation from the Rydberg sensor node 28. In some examples, however, the transmitter node 38 may be on one platform with Rydberg sensor node 28. In the examples of FIGS. 1 and 2, the transmitter node 38 is co-located with the receiver node 24. Spaced apart relation may indicate that nodes are geographically spaced, such as explained below with specific examples. Also, the Rydberg sensor node 28 may be housed on a different platform than the receiver node 24, or on the same platform, such as an airplane. The coupling laser 30 and probe laser 32 may be housed on one or more transmitter nodes in spaced apart relation from the Rydberg sensor node 28. A laser may be onboard the Rydberg sensor node 24, another laser at a ground node, and another laser at a separate ground node, or combinations thereof. A plurality of lasers as the coupling laser 30 may excite the Rydberg sensor node 28 into a Rydberg state, such as described in U.S. Patent No. 11,815,538 to Bucklew et al., assigned to Eagle Technology, LLC, the disclosure which is hereby incorporated by reference in its entirety.

The Rydberg sensor node 28 may include an aerial propulsion system 40 and a controller 42 coupled thereto to operate the Rydberg sensor node as an aerial drone in some embodiments. In other embodiments, the receiver node 24 may be a terrestrial or ground-based receiver node co-located with the transmitter node 38. The Rydberg sensor node 28 may operate as a drone similar to an elevated antenna, and receives the desired RF signals 36, which alter the measured attenuation of the probe laser beam by converting the response of an atomic vapor in the Rydberg cell as a Rydberg sensor 44 to the RF radiation into measured changes in the optical probe laser beam.

A transmitter node controller 46 at the transmitter node 38 is connected to the coupling laser 30 and the probe laser 32 and is configured to operate the coupling laser and probe laser and tune the coupling laser so that the Rydberg sensor 44 responds at a desired RF frequency range at the Rydberg sensor node 28. In the example of the Rydberg sensor node 28 configured with the aerial propulsion system 40 and operating as a drone, the laser output from the Rydberg sensor node 28 may be a free space laser output beam 50 shown by the solid line referenced free space in FIG. 1. A detector 83 at the receiver node 24 receives the laser output 34, which may be processed at the receiver node controller/processor 54.

The receiver node 24 and Rydberg sensor node 28 may each comprise a respective pointing and tracking arrangement (P&T) 52a,52b for the free space laser output beam 50. The Rydberg sensor controller 42 may operate the pointing and tracking arrangement 52a at the Rydberg sensor node 28. The receiver node 24 may include a separate receiver node controller 54 to operate the pointing and tracking arrangement 52b at the receiver node for the free space laser output beam 50.

For example, the laser output 34 from the Rydberg sensor node 28 to the receiver node 24 may operate as an alignment beam and adjustments may be made to the respective pointing and tracking arrangements 52a,52b to ensure laser alignment. It is possible that the Rydberg sensor node 28 may generate a separate alignment beam that includes alignment data for an optical beam entrance aperture at the pointing and tracking arrangement 52b at the receiver node 24. An alignment beam may be applicable when the transmitter node 38 and receiver node 24 are co-located, so that the coupling laser 30 and probe laser 32 may be aligned with the Rydberg sensor node 28, for example, when the Rydberg sensor node is an aerial drone. An example optical pointing and tracking arrangement 52a,52b that may be used with the system 20 as described is disclosed in U.S. Patent Application No. 18/499,715, filed Nov. 1, 2023, the disclosure which is hereby incorporated by reference in its entirety.

It is also possible for the receiver node 24 and Rydberg sensor node 28 in other embodiments to be underwater and the laser output 34 may be formed as an underwater laser output beam 58 as shown in FIG. 1. In another example embodiment, an optical fiber 60 may be between the receiver node 24 and Rydberg sensor node 28 and the laser output 34 and may be formed as an optical fiber laser output 62. In an example, the optical fiber laser output 62 is coupled into the optical fiber 60, forming an optical tether that operates as an optical umbilical to the Rydberg sensor node 28 when operating as a drone, which can be elevated above a tree canopy or other obstacles and have a direct line-of-sight to a satellite or other transmitter of RF signals 36 so that the Rydberg sensor node operates as a “stand-up” RF Rydberg antenna.

The system 20 may be formed from components such as described in the incorporated by reference ‘798 patent. An example of the system 20 generally described with reference to FIG. 1 may have the transmitter node 38 and receiver node 24 contained within one housing or platform 64 as shown in greater detail in the block diagram of FIG. 2. The transmitter node 38 and receiver node 24 are co-located and contained in the same housing as one platform 64, which could be located on the ground or include components for a drone or be located on an aircraft or other locations.

As illustrated, the housing 64 as a single platform supports the coupling laser 30 and probe laser 32, which transmit their respective laser beams to a first wavelength division multiplexer (WDM) 66 that merges both laser beams. Polarization is controlled as the merged laser beam passes through an E-polarization controller 70 and first optical circulator (C1) 72 for subsequent transmission in a free space laser output beam 50, an underwater laser output beam 58, or optical fiber 60 such as an optical fiber tether for an optical fiber laser output 62.

The optical beam is received at the Rydberg sensor node 28, where it is split into the two beams by a second wavelength division multiplexer (WDM) 74. A first beam passes through a second optical circulator 76 and optical collimator 78 into the Rydberg cell, which in this example may be a Rydberg vapor cell 80. The received RF signals 26 may be generated from a plane, satellite or other RF transmission source either on the ground or as an aerial transmitter. The split laser beam passes through the second collimator 84, and in this example, into a deformable mirror (DM) 82, which receives an optical signal from the vapor cell 80 and passes it into a third collimator 86 for feedback to the second optical circulator 76 and then back through the second WDM 74. The deformable mirror 82 achieves wavefront control and correction of optical aberrations. The optical beam returns to the second optical circulator 76, into the second wavelength division multiplexer 74, and back to the co-located transmitter node 38 and receiver node 24, where it passes through the first optical circulator 72 and into a detector 90 as part of the receiver node 24 and then processed at a digital signal processor (DSP) 92, which may also operate as part of the receiver node controller/processor 54.

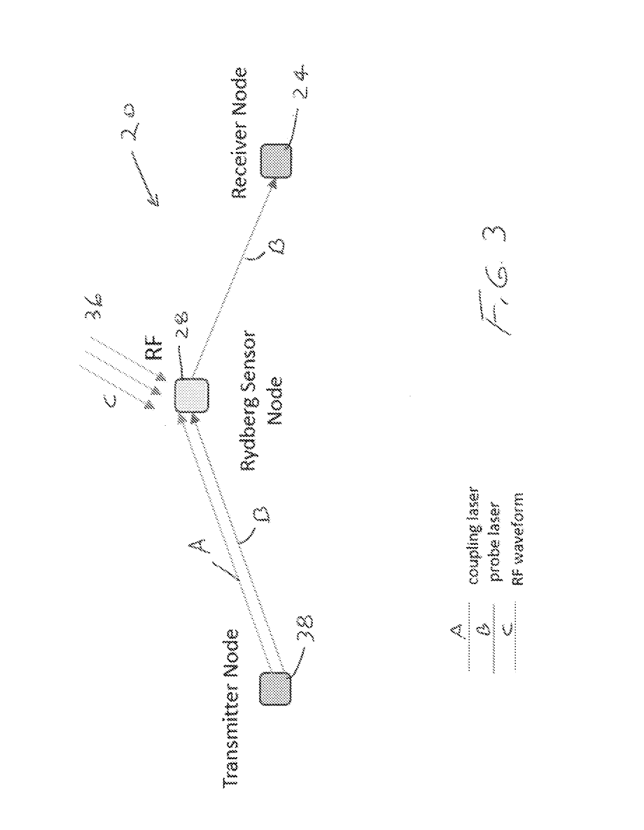

Referring now to FIG. 3, there is illustrated a schematic diagram showing an example where the receiver node 24 is separate and spaced apart from the transmitter node 38 and the Rydberg sensor node 28. In this example, the Rydberg sensor node 28 may receive the RF signals 36, such as from a drone, an RF device located on the ground, a plane, or other RF source. The transmitter node 38 having the coupling laser 30 and probe laser 32 energizes the Rydberg sensor node 28 via the coupling laser beam. The attenuation of the probe laser 32 due to absorption in the Rydberg sensor node 28 having a Rydberg vapor cell, for example, is caused by the local electric fields from the received RF signals 36, which alter the measured attenuation of the probe laser and is detected at the receiver node 24 such as by an optical detector 83. The system 20 shown in FIG. 3 may operate as a back-up for RF service denied areas and RF jammed networks, or operate for covert RF collections and communications. Because the Rydberg sensor node 28 is spaced apart from the receiver node 24 and transmitter node 38, which are also spaced apart, all components may be a Size, Weight, and Power (SWaP) limited.

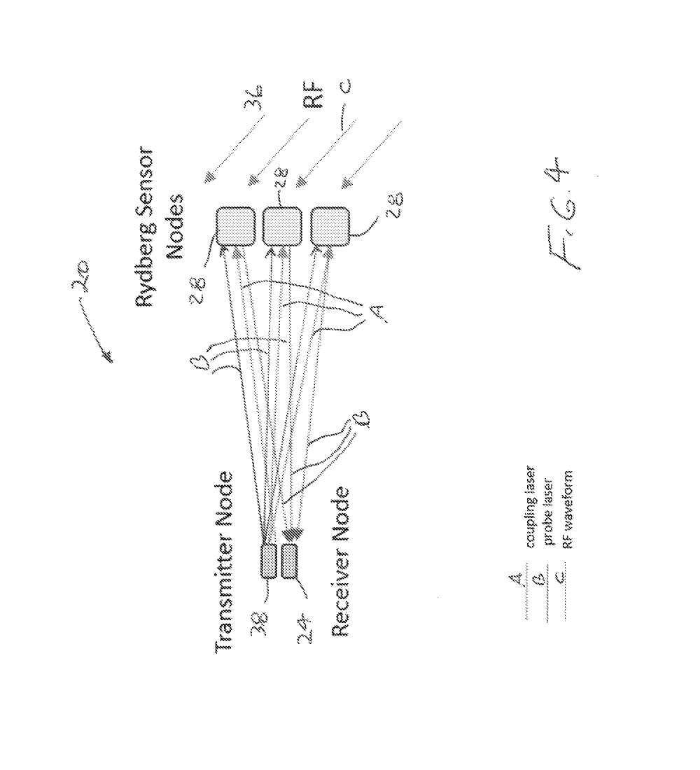

Referring now to FIG. 4, at least one other Rydberg sensor node may be included within the system 20. The Rydberg sensor nodes are shown collectively as 28, 28a and 28b for a plurality of Rydberg sensor nodes, which cooperate with the receiver node 24 and the coupling laser 30 and probe laser 32 at the transmitter node 38. In this example, three passive Rydberg sensor nodes 28, 28a, 28b are illustrated, but a larger number may be employed. The multiple Rydberg sensor nodes 28, 28a, 28b may be used for angle-of-arrival (AOA) determinations and may form a reconfigurable antenna shape by changing the distance to ground for the Rydberg sensor nodes and optimize the collection of RF signals. There may be multiple Rydberg sensor nodes 28, 28a, 28b, each operating at a distance from each other and from the ground to form a large antenna system.

It is also possible to employ spatial point mapping for electronic field imagery such as for ISAR/SAR type applications where the multiple Rydberg sensor nodes 28, 28a, 28b operate similar to a camera. The Rydberg sensor nodes 28, 28a, 28b could each be located on a separate drone, thus allowing the positioning of each drone in a particular location spaced from each other and at selected elevations to configure a larger antenna.

When one or more different Rydberg sensor nodes 28 are used, there is usually a power difference between the probe laser 32 and the coupling laser 30. Usually the coupling power in the coupling laser 30 is much higher than the power used in the probe laser 32. For example, the power of the probe laser 32 may be in the microwatts to milliwatts range, while the power of the coupling laser 30 may be in the tens of milliwatts, such as 40 to 100 milliwatts range, depending on the spot size of the laser beam at the Rydberg sensor node 28.

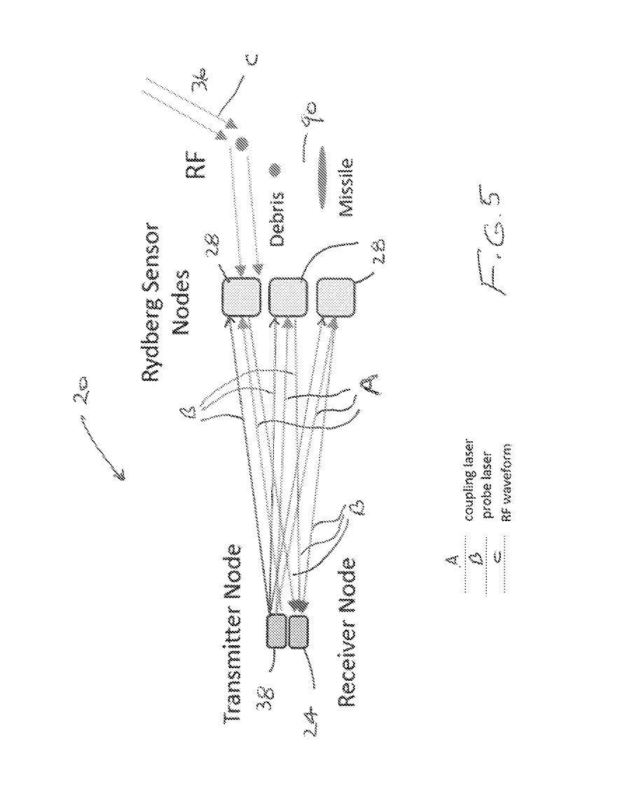

The configuration having multiple Rydberg sensor nodes 28, 28a, 28b shown in FIG. 4 may also be used as a passive radar, or used to scavenge RF signals 36 from the environment. Each separate Rydberg sensing node 28, 28a, 28b may carry a small parabolic dish type antenna to focus the RF radiation based on the RF signals 36. An example of the system 20 for scavenging RF signals 36 is shown in FIG. 5, where Rydberg sensor nodes 28, 28a, 28b are each optically connected to the transmitter node 38 and receiver node 24 that are co-located. The Rydberg sensor nodes 28, 28a, 28b may operate as an advanced or early warning detection system for satellites based upon monitoring the scattered RF radiation as RF signals 36 from debris or flying objects 90, similar to a passive radar system.

Other applications for the system 20 may include back haul communications using small space sensors with cross-linked distances ranging from a few kilometers to thousands of kilometers. An underwater application may include an optical fiber cable, or include free-space laser beams transmitted through the fluid from the probe laser 32 and coupling laser 30 to the Rydberg sensor node 28, which in turn, generates a laser output 34 to the receiver node 24 based upon the received RF signals 36. There may also be a back-up layer of RF communications with the Rydberg sensor node 28 in case existing and traditional RF communications between the different nodes are disrupted. RF waveforms may be transmitted between the various nodes of the system 20.

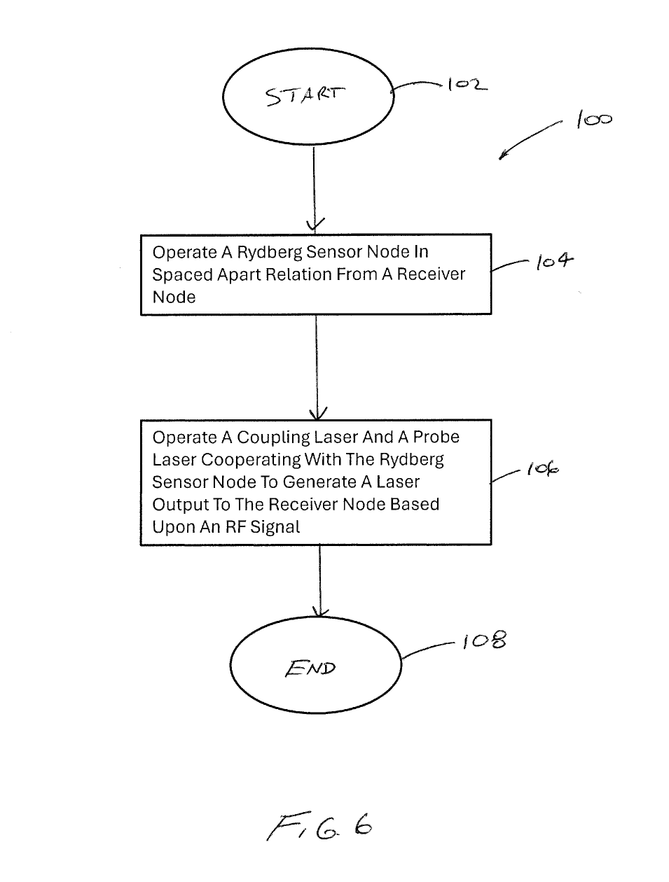

Referring now to FIG. 6, there is illustrated generally at 100 a flowchart showing an example of receiving a radio frequency (RF) signal 36. The process starts (Block 102) by operating a Rydberg sensor node 28 in spaced apart relation from a receiver node 24 (Block 104). The method further includes operating a coupling laser 30 and a probe laser 32 cooperating with the Rydberg sensor node 28 to generate a laser output to the receiver node 24 based upon an RF signal 36 (Block 106). The process ends (Block 108).

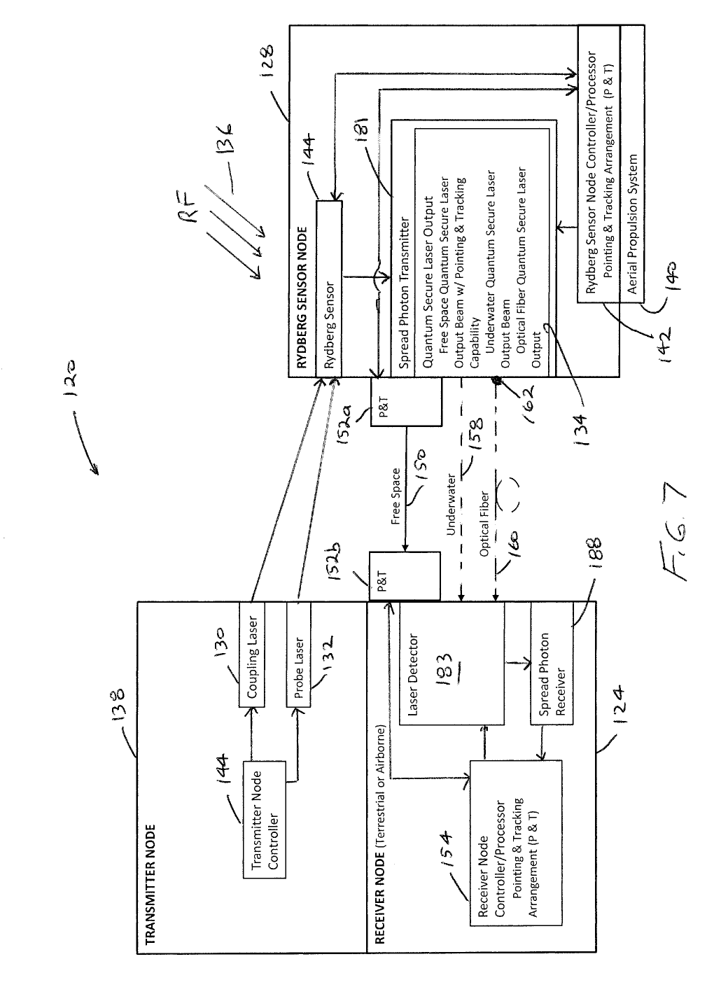

Referring now to FIG. 7, there is illustrated a system 120 similar to the system 20 described relative to FIGS. 1-6, except the system 120 has its Rydberg sensor node 128 configured to generate a quantum secure laser output 134 to the receiver node 124 based upon the received radio frequency (RF) signal 136. Components in the system 120 similar to the components described in the system 20 are given similar reference numerals, but in the 100 series.

The system 120 provides for more secure communications in contested airspace. The system 120 includes the spaced apart receiver node 124 from the Rydberg sensor node 128 as in the system 20 of FIG. 1. The Rydberg sensor node 128 generates the quantum secure laser output 134 to the receiver node 124 based upon the received radio frequency (RF) signal 136 such as transmitted from a ground device, satellite, aircraft, drone, or other device.

The Rydberg sensor node 128 includes a Rydberg sensor 144 and a spread photon transmitter 181 coupled thereto that generates the quantum secure laser output 134. As in the system 20 of FIG. 1, the coupling laser 130 and probe laser 132 cooperate with the Rydberg sensor node 128. The coupling laser 130 and probe laser 132 may be integrated into one transmitter node 138 in spaced apart relation from the Rydberg sensor node 128. The probe laser beam is attenuated at the Rydberg sensor 144 and the RF waveform of interest is encoded by the spread photon transmitter 181, which encodes the RF information, attenuates it in some examples, and transmits it to the receiver node 124, which in an example, may be co-located with the transmitter node 138 or separate.

The quantum secure laser output 134 may be a free space quantum secure laser output beam 150 that even in a contested airspace would be difficult to jam or intercept to determine the encoded data. Any tampering to the quantum secure laser output 134 would be detected at the receiver node 124. Any tampering or attempt to obtain information is protected provided the user follows the prescribed quantum secure protocol, which is based on the spread photon transceiver, an example protocol of quantum data locking.

It is also possible that the receiver node 124 and the Rydberg sensor node 128 each includes a respective pointing and tracking arrangement 152a, 152b for the free space quantum secure laser output beam 150 similar in function to the pointing and tracking arrangement 52a,52b in the system 20 of FIG. 1. The receiver node controller/processor 154 operates in conjunction with the pointing and tracking arrangement 152b, while the Rydberg sensor node controller/processor 142 operates in conjunction with the pointing and tracking arrangement 152a. The Rydberg sensor node 128 may include an aerial propulsion system 140 and a Rydberg sensor node controller 142 coupled thereto forming a drone. The receiver node 124 may be a terrestrial receiver node located on the ground such as operated by an individual, and a drone carrying the Rydberg sensor node 128 may operate as a stand-up antenna.

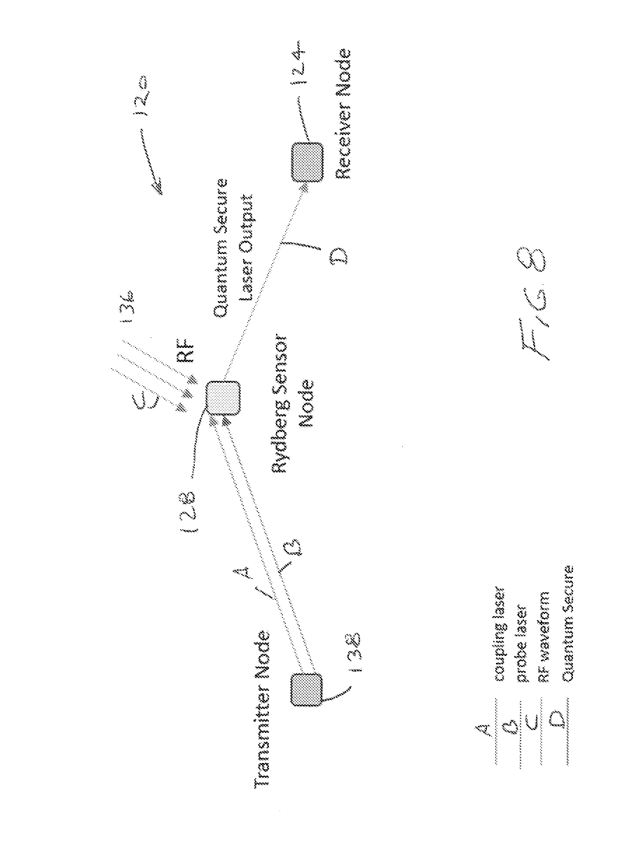

The receiver node 124 and the Rydberg sensor node 128 may be underwater and the quantum secure laser output 134 may be formed as an underwater quantum secure laser output beam 158. An optical fiber 160 may be between the receiver node 124 and Rydberg sensor node 128. The quantum secure laser output 134 includes an optical fiber quantum secure laser output 162. Thus, the optical fiber 160 may be an optical tether for a drone forming a stand-up antenna. It is also possible for the Rydberg sensor node 128, receiver node 124, and transmitter node 138 to be spaced apart from each other as shown in FIG. 8 and function similar to the system 20 shown in FIG. 3, but instead, generating a quantum secure laser output 134.

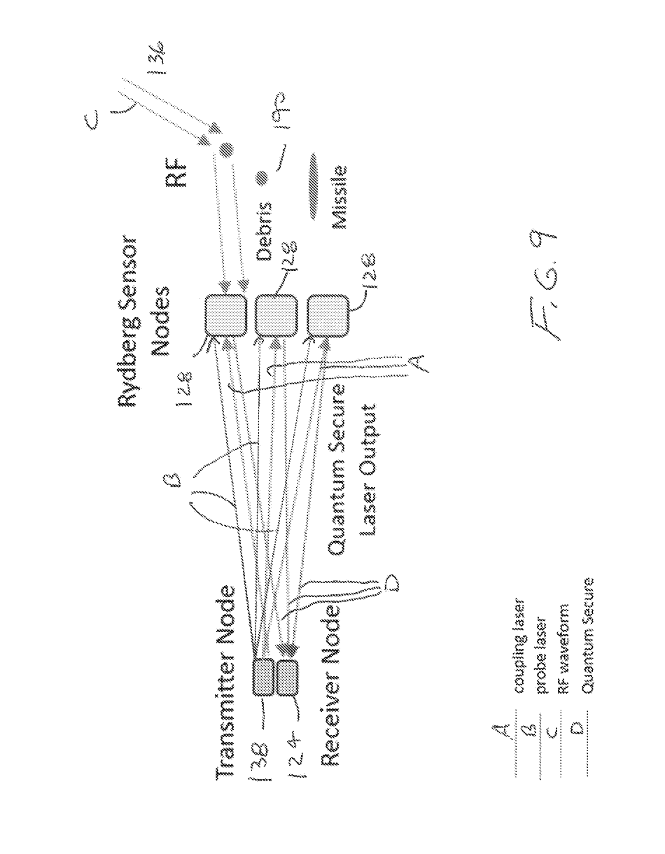

As shown in FIG. 9, at least one other Rydberg sensor node shown as three Rydberg sensor nodes 128, 128a, 128b may cooperate with the receiver node 124 and the coupling laser 130 and probe laser 132 similar to the system 20 of FIG. 1 to allow angle-of-arrival measurements and permit a reconfigurable antenna shape by changing the distance to ground for the different Rydberg sensor nodes and optimize collection of RF signals or engage in spatial point mapping. The Rydberg sensor nodes 128, 128a, 128b may also be used as an advanced warning for satellites when debris or a missile 190 approaches as described relative to the system of FIG. 1.

In an example, the quantum secure laser output 134 from the Rydberg sensor node 128 may have a 40+ GHz sampling rate that is spatio-temporal multiplexed. The spread photon transmitter 181 generates the quantum secure laser output 134 and cooperates with a laser detector 183 and spread photon receiver 185 at the receiver node 128 and may include various components included in a quantum communications system having pulses divided into time bins and using a pulse divider as described in U.S. Patent Nos. 11,451,308 and 11,502,758, assigned to Eagle Technology, LLC, the disclosures which are hereby incorporated by reference in their entirety.

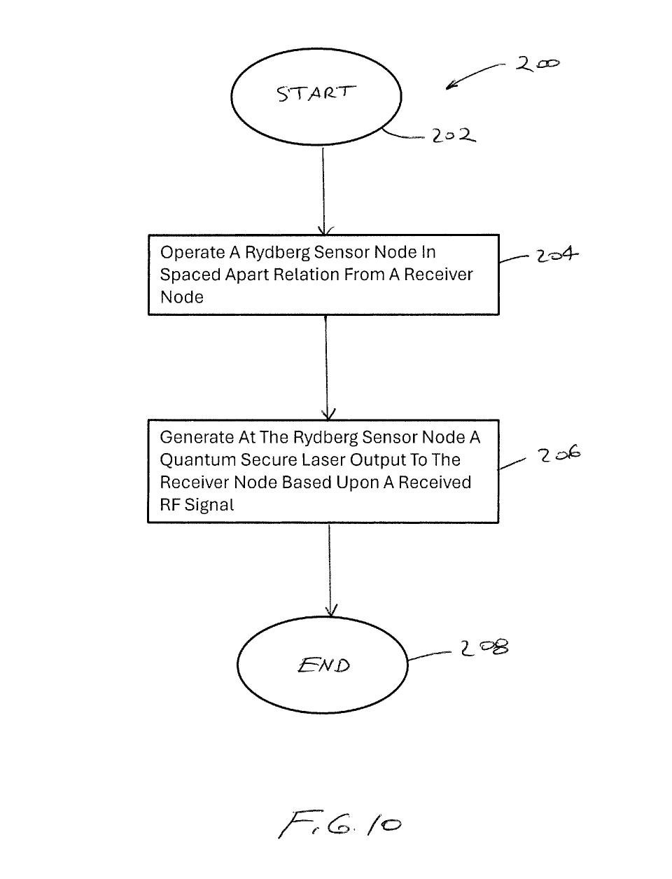

Referring now to FIG. 10, there is illustrated generally at 200 a flowchart showing an example method for radio frequency (RF) communication. The process starts (Block 202). The Rydberg sensor node 128 operates in spaced apart relation from a receiver node 124 (Block 204). The Rydberg sensor node 128 generates a quantum secure laser output 129 to the receiver node 124 based upon a received RF signal 136 (Block 206). The process ends (Block 208).

This application is related to copending patent applications entitled, “SYSTEM HAVING RECEIVER NODE AND SPACED APART RYDBERG SENSOR NODE THAT GENERATES A QUANTUM SECURE LASER OUTPUT AND ASSOCIATED METHODS,” which is filed on the same date and by the same assignee and inventors, the disclosure which is hereby incorporated by reference.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A system comprising:
a receiver node;
a Rydberg sensor node in spaced apart relation from the receiver node; and
a coupling laser and a probe laser cooperating with the Rydberg sensor node to generate a laser output to the receiver node based upon a received radio frequency (RF) signal.

2. The system of claim 1 wherein the coupling laser and probe laser define a transmitter node in spaced apart relation from the Rydberg sensor node.

3. The system of claim 2 wherein the transmitter node is co-located with the receiver node.

4. The system of claim 1 wherein the laser output comprises a free space laser output beam.

5. The system of claim 4 wherein the receiver node and the Rydberg sensor node each comprises a respective pointing and tracking arrangement for the free space laser output beam.

6. The system of claim 1 wherein the receiver node and the Rydberg sensor node are underwater; and wherein the laser output comprises an underwater laser output beam.

7. The system of claim 1 comprising an optical fiber between the receiver node and Rydberg sensor node; and wherein the laser output comprises an optical fiber laser output.

8. The system of claim 1 wherein the Rydberg sensor node comprises an aerial propulsion system and a controller coupled thereto.

9. The system of claim 8 wherein the receiver node comprises a terrestrial receiver node.

10. The system of claim 1 comprising at least one other Rydberg sensor node cooperating with the receiver node and the coupling laser and probe laser.

11. A system comprising:
a receiver node;
a Rydberg sensor node in spaced apart relation from the receiver node; and
a coupling laser and a probe laser defining a transmitter node in spaced apart relation from the Rydberg sensor node and cooperating with the Rydberg sensor node to generate a free space laser output to the receiver node based upon a received radio frequency (RF) signal.

12. The system of claim 11 wherein the transmitter node is co-located with the receiver node.

13. The system of claim 11 wherein the receiver node and the Rydberg sensor node each comprises a respective pointing and tracking arrangement for the free space laser output beam.

14. The system of claim 11 wherein the receiver node and the Rydberg sensor node are underwater.

15. The system of claim 11 wherein the Rydberg sensor node comprises an aerial propulsion system and a controller coupled thereto.

16. The system of claim 15 wherein the receiver node comprises a terrestrial receiver node.

17. The system of claim 11 comprising at least one other Rydberg sensor node cooperating with the receiver node and the coupling laser and probe laser.

18. A method of receiving a radio frequency (RF) signal comprising:
operating a Rydberg sensor node in spaced apart relation from a receiver node; and
operating a coupling laser and a probe laser cooperating with the Rydberg sensor node to generate a laser output to the receiver node based upon an RF signal.

19. The method of claim 18 wherein the coupling laser and probe laser define a transmitter node in spaced apart relation from the Rydberg sensor node.

20. The method of claim 19 wherein the transmitter node is co-located with the receiver node.

21. The method of claim 18 wherein the laser output comprises a free space laser output beam.

22. The method of claim 18 wherein the receiver node and the Rydberg sensor node are underwater; and wherein the laser output comprises an underwater laser output beam.

23. The method of claim 18 comprising an optical fiber between the receiver node and Rydberg sensor node; and wherein the laser output comprises an optical fiber laser output.

24. The method of claim 18 wherein the Rydberg sensor node comprises an aerial propulsion system and a controller coupled thereto, and the receiver node comprises a terrestrial receiver node.

25. The method of claim 18 comprising operating at least one other Rydberg sensor node cooperating with the receiver node and the coupling laser and probe laser.
